(19) United States
(12) Patent Application Publication
(10) Pub. No.: US 2025/0346036 A1
(43) Pub. Date: Nov. 13, 2025

(54) INK CONTAINER AND INK REFILL SYSTEM

(71) Applicant: CANON KABUSHIKI KAISHA, Tokyo (JP)

(72) Inventors: TAKANORI YASHIRO, Kanagawa (JP); DAISUKE NAKAGAWA, Kanagawa (JP)

(21) Appl. No.: 19/199,055

(22) Filed: May 5, 2025

(30) Foreign Application Priority Data
May 8, 2024 (JP) 2024-075571

(51) Int. Cl. B41J 2/175

(52) U.S. Cl. CPC B41J 2/17509

(57) ABSTRACT

An ink container for supplying ink into a receptacle of an ink ejector, the ink container including an ink container body configured to hold the ink and a spout having an outlet through which the ink held inside the ink container body is dispensed to outside, in which the ink container body is formed of a paper material internal of which is covered by a material that is impermeable to ink, and the ink container body has a shape becoming narrower toward the spout.

### BACKGROUND OF THE INVENTION

### Field of the Invention

The present disclosure relates to an ink container and an ink refill system used in an ink ejector.

### Description of the Related Art

As a known example of an ink ejector for ejecting ink for recording, there is an inkjet recording apparatus. This inkjet recording apparatus makes recording by ejecting very small ink droplets from an inkjet recording head that is a liquid ejection unit, and forming characters and images on a recording medium thereby. Inkjet recording apparatuses are used as home or office appliances, and have spread to industrial applications. A container for ink that is a recording material of the inkjet recording apparatus is mainly made from a plastic material, and is used to refill the ink into the inkjet recording apparatus through an inlet for injecting ink into the inject recording apparatus, the inlet being provided to the inkjet recording apparatus.

In recent years, every industry that develops, produces, and sells products is demanded to develop products alleviating global environmental burdens. Examples of conventional methods for alleviating environmental burdens caused by any liquid containers such as ink containers include recycling and reusing. As a method for alleviating environmental burdens, reducing has recently come to put into practice. Reducing uses paper materials or biodegradable plastics as a substitute of the plastic materials that are used for liquid containers.

Japanese Patent Application Laid-open No. 2001-303500 discloses a bottle-shaped molded article having strength, durability, moisture-impermeability, or high-quality design by integrating a basic structural part that is made from a fiber laminate, which uses fibers such as pulp fibers as a main raw material, and another structural part having a different layered structure and a different material composition from those of the basic structural part.

### SUMMARY OF THE INVENTION

If the plastic materials used for ink containers are substituted with paper materials to alleviate the global environmental burdens, it becomes necessary to reuse or to dispose the containers made from paper materials again, e.g., by burning, after the use of the ink containers, from the viewpoint of alleviating the environmental burdens. To enable smooth disposal or reuse of the ink containers, it is ideal to use up the ink inside the ink container as thoroughly as possible. The inventors have found out that the bottle-shaped article disclosed in Japanese Patent Application Laid-open No. 2001-303500 has obstructed the ink held the ink container from being used up.

The present disclosure is directed to an ink container and an ink refill system that maximizes use of ink inside the container by allowing the ink to flow smoothly inside the container toward the ink outlet, when ink is refilled into an inkjet recording apparatus.

The present disclosure relates to an ink container for supplying ink to a receptacle of an ink ejector,
the ink container comprising:
   an ink container body configured to hold the ink; and
   a spout having an outlet through which the ink held inside the ink container body is dispensed to outside, wherein
the ink container body is formed of a paper material internal of which is covered by a material that is impermeable to ink,
when a horizontal direction is a direction extending along a bottom surface of the ink container body, a vertical direction is a direction perpendicular to the bottom surface; a top surface is a surface on an opposite side of the bottom surface of the ink container body in the vertical direction;
S1 denotes a horizontal cross-sectional area of the bottom surface;
S2 denotes a horizontal cross-sectional area of the top surface;
S3 denotes a horizontal cross-sectional area at a midpoint between the bottom surface and the top surface in the vertical direction;
D1 denotes a horizontal cross-sectional area at a position between the bottom surface and the midpoint in the vertical direction; and
D2 denotes a horizontal cross-sectional area at a position between the midpoint and the top surface in the vertical direction,
the ink container satisfies following Relational Expressions (1) to (4):

$$0.25 \leq S 3 / S 1 \leq 1. ; \qquad ( 1 )$$

$$0.04 \leq S 2 / S 3 < 1. ; \qquad ( 2 )$$

$$S 1 \geq D 1 \geq S 3 ; and \qquad ( 3 )$$

$$S 3 > D 2 > S 2. \qquad ( 4 )$$

The present disclosure relates to an ink refill system comprising:
an ink ejector; and
an ink container, wherein
the ink ejector includes:
   an ink ejection head;
   a receptacle configured to receive an injection of ink from outside; and
   an ink tank enabled to supply the ink injected from the receptacle into the ink ejection head, and
the ink container is configured to supply ink into the receptacle, and
the ink container is the above ink container.

The present disclosure can provide an ink container and an ink refill system that maximizes use of ink inside the container by allowing the ink to flow smoothly inside the container toward the ink outlet, when ink is refilled into an inkjet recording apparatus.

Further features of the present invention will become apparent from the following description of exemplary embodiments with reference to the attached drawings.

### BRIEF DESCRIPTION OF THE DRAWINGS

FIG. 1 is a perspective view of an inkjet recording apparatus according to a first embodiment, being refilled with ink;

FIG. 2 is a side view of an ink container according to the first embodiment;

FIGS. 3A and 3B are side views of the ink container at the time of refilling the ink, in the first embodiment;

FIG. 4 is a side view of the ink container according to the first embodiment;

FIG. 5 is a side view of an ink container according to a second embodiment;

FIGS. 6A and 6B are side views of an ink container according to a third embodiment;

FIGS. 7A and 7B are side views of an ink container according to a fourth embodiment;

FIG. 8 is a side view of an ink container according to a fifth embodiment; and

FIG. 9 is a side view of the ink container according to this embodiment.

### DESCRIPTION OF THE EMBODIMENTS

In the present disclosure, the description such as “from XX to YY” and “XX to YY” representing a numerical range means that such a numerical range includes the lower and upper bounds, which are endpoints, unless specified otherwise. If numerical ranges are described in stages, the upper and lower bounds of such numerical ranges may be combined in any way.

Embodiments of the present disclosure will now be described with reference to the accompanying drawings.

### First Embodiment

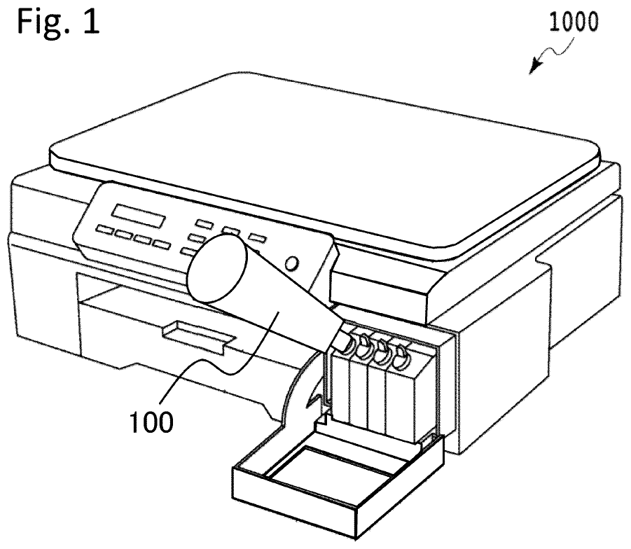

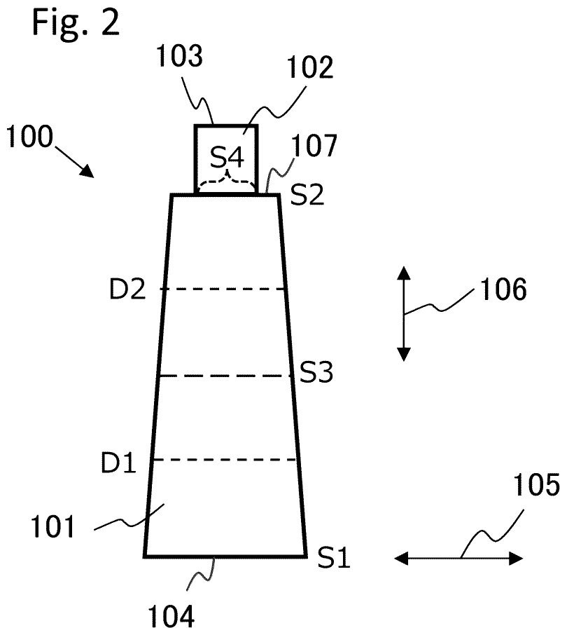

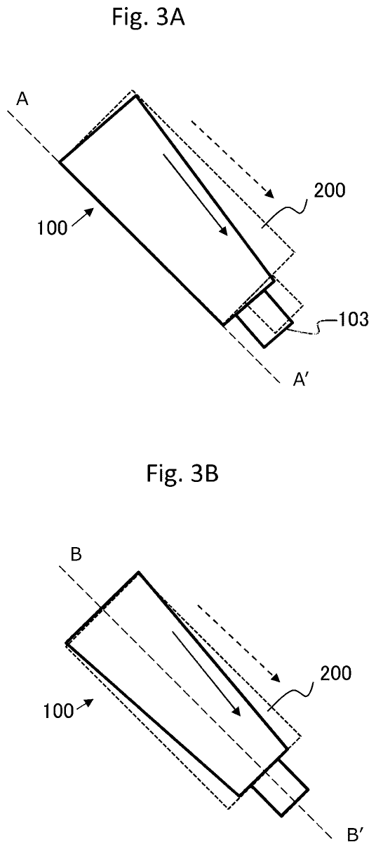

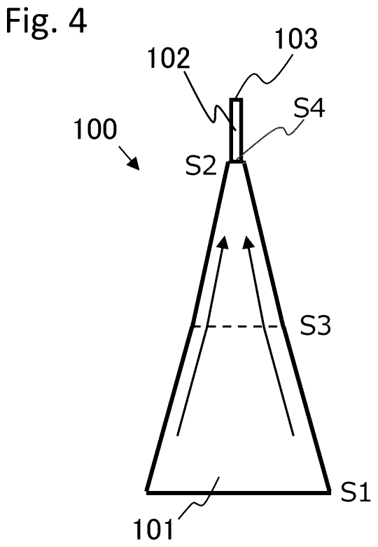

FIG. 1 is a perspective view of an inkjet recording apparatus that is an ink ejector, being refilled with ink. FIGS. 2 and 4 are side views of an ink container according to the first embodiment of the present disclosure. FIGS. 3A and 3B are side views of the ink container at the time of refilling the ink.

An ink ejector (inkjet recording apparatus 1000) includes an ink ejection head, a receptacle configured to receive injection of ink from outside, an ink tank enabled to supply the ink received from the receptacle into the ink ejection head.

The ink container according to the present disclosure is for supplying the ink into the receptacle of the ink ejector. The present disclosure also relates to an ink refill system including an ink ejector and an ink container.

As illustrated in FIG. 2, this ink container 100 includes an ink container body 101 for holding ink, and a spout 102 having an outlet 103 through which the ink held in the ink container body 101 is dispensed to the outside. The ink contains a coloring material, a solvent, a surfactant, and water, for example.

FIG. 1 illustrates how the ink is supplied into the inkjet recording apparatus 1000. A user lifts the ink container 100 by hand, with respect to an inlet for injecting ink, the inlet being provided to the inkjet recording apparatus, and tilts the ink container 100 in a direction bringing the outlet 103 closer to the direction of the gravity. By tilting the ink container 100, the gravity moves the ink stored in the ink container body 101 toward the outlet 103, and the ink is filled into the inkjet recording apparatus through the inlet provided to the inkjet recording apparatus.

The ink container body 101 is made of a paper material, and inside of the ink container body 101 is covered by a material that is impermeable to ink. Preferably, such ink-impermeable material includes at least one selected from the group consisting of a plastic film and a coating layer. As the plastic film, any known film made of a waterproof resin may be used. Examples of the resin include polyolefins such as polyethylene and polypropylene. The coating layer is preferably waterproof coating, such as a layer of varnish or sealant. It is preferable for the ink-impermeable material to also have ink resistance and a gas barrier property. There is no limitation to the ink-impermeable materials, and the material may be changed as appropriate, depending on the ink container and the ink type.

The paper material is mainly made from pulp fibers. Being “mainly made from” means occupying up 50 mass % to 100 mass % of the content. From the viewpoint of recycling, the paper material preferably contains the pulp fibers by 80 mass % to 100 mass %. One example of the method for forming the ink container body 101 using a paper material includes a method of forming a fiber laminate such as a laminate of pulp fibers, using a pulp mold. The method of forming the ink container body 101 from the paper material is not limited to any particular method, and any other known method may be used.

Means for coating the paper material with an ink-impermeable material is not limited to any particular means, either. When a plastic film is used as an ink-impermeable material, the paper material may be covered by laminating the paper material with the plastic film, for example, using known means. In this embodiment, a laminate film using polyethylene is used as an ink-resistant layer coming into contact with ink. When used is a coating layer, the layer of coating may be formed on the inner side of the ink container by applying a coating of a varnish or a sealant material.

From the viewpoint of recycling and reducing the amount of plastic, it is preferable for the ink-impermeable material contained in the ink container body 101 to be small. The ink-impermeable material content preferably occupies 1 mass % to 30 mass %, more preferably 1 mass % to 15 mass % of the mass of the ink container body 101. The paper material content preferably occupies 70 mass % to 99 mass %, more preferably 85 mass % to 99 mass % of the mass of the ink container body 101.

When the ink container body 101 contains these materials within the ranges mentioned above, because the amount of ink-impermeable material is small, the inner surface of the ink container body 101 may have extremely fine unevenness corresponding to extremely fine unevenness on the paper material, and the unevenness may obstruct the flows of the ink. Even with such settings, however, by satisfying following Relational Expressions (1) to (4) according to the present disclosure, the ink inside the ink container can be used up more thoroughly.

The spout 102 having the outlet 103 for the ink may also be formed integrally with the ink container body 101, using the same materials and configuration as those of the ink container body 101. The spout 102 may also be a part separate from the ink container body 101, and may be made from another material, such as a plastic, instead of a paper material. It is also possible to, after forming the spout 102 using another material, form the ink container 100 by mechanically fastening the spout 102 to the ink container body 101 with screws, fitting the spout 102 into the ink container body 101, or joining the spout 102 to the ink container body 101 by insert molding, welding the spout 102 to the ink container body 101 by heat or laser, or by bonding the spout 102 to the ink container body 101 using an adhesive.

The bottom surface of the ink container body 101 of the ink container 100 will be referred to as a bottom surface 104. A direction extending along the bottom surface 104 of the ink container body 101 is defined as a horizontal direction 105, and a direction perpendicular to the bottom surface 104 is defined as a vertical direction 106. The surface on the opposite side of the bottom surface 104 of the ink container body 101 in the vertical direction will be referred to as a top surface 107. The ink container 100 has a shape becoming smaller from the bottom surface 104 of the ink container body 101 toward the top surface 107 on the side of the spout 102.

Specifically, the shape of the ink container 100 satisfies following Relational Expressions (1) to (4), where a horizontal cross-sectional area of the bottom surface 104 of the ink container body 101 is S1; a horizontal cross-sectional area of the top surface 107 is S2; a horizontal cross-sectional area of a midpoint between the bottom surface and the top surface in the vertical direction is S3; a horizontal cross-sectional area of a point between the bottom surface and the midpoint in the vertical direction is D1; and a horizontal cross-sectional at a point between the midpoint and the top surface in the vertical direction is D2.

$$0.25 \leq S 3 / S 1 \leq 1. \qquad ( 1 )$$

$$0.04 \leq S 2 / S 3 < 1. \qquad ( 2 )$$

$$S 1 \geq D 1 \geq S 3 \qquad ( 3 )$$

$$S 3 > D 2 > S 2 \qquad ( 4 )$$

The shape preferably further satisfies a relationship S2>S4, where S4 is a horizontal cross-sectional area of a surface of the spout 102 facing the ink container body 101.

The horizontal cross sections forming S1, S2, S3, S4, D1, and D2 preferably have circular or elliptical shapes, from the viewpoint of productivity, but may also have another shape such as square, rectangular, or triangular shapes.

By using a shape satisfying Relational Expressions (1) to (4) for the ink container 100, the ink inside the ink container is allowed to flow smoothly toward the ink outlet of the ink container when the ink is refilled into the inkjet recording apparatus. Therefore, it is possible to thoroughly use up the ink inside the ink container.

Specifically, as illustrated in FIGS. 3A and 3B, a user lifts the ink container 100 by hand, with respect to the inlet for injecting ink provided to the inkjet recording apparatus, and tilts the ink container 100 in a direction bringing the outlet 103 toward the direction of the gravity.

It is assumed herein that the ink container 100 is tilted so that the side surface of the ink container body 101 included in the ink container 100 becomes tilted with respect to a line A-A′ as a reference, as illustrated in FIG. 3A. With the effect of the ink container 100 having the narrowing shape, the ink inside the ink container body 101 becomes collected more smoothly into the spout 102, by the gravity, compared with the ink in a cylindrical ink container 200 (illustrated by dotted lines), for example.

The ink becomes also collected more smoothly, in the same manner, into the spout 102 when the ink container 100 is tilted with respect to a line B-B′ passing through the ink container body 101 as a reference, as illustrated in FIG. 3B. With this, the ink is refilled into the inkjet recording apparatus smoothly, through the inlet provided in the inkjet recording apparatus. As a result, it becomes possible to use up the ink inside the ink container more thoroughly. Such an ink container therefore better contributes to the alleviation of the environmental burdens.

The technologies described in this specification have the potential to contribute to the achievement of a sustainable society, such as a decarbonized society/circular society.

When S3/S1 satisfies Relational Expression (1), the effect of the ink becoming collected into the spout 102 can be achieved more easily, while ensuring a sufficient volume of ink inside the ink container body 101. Examples of S3/S1 include 0.25 to 0.90, 0.25 to 0.80, and 0.25 to 0.70. When S3/S1 is within these ranges, it becomes easier to achieve the effects of ensuring a sufficient ink volume as well as of allowing the ink to be used up at the same time.

In relation to Relational Expression (2), when S2/S3 is at least 0.04, the speed at which the ink is dispensed is less likely to slow down. When S2/S3 is lower than 1, it is possible to achieve the effect of allowing the ink to become collected into the spout 102. Examples of S2/S3 include 0.10 to 0.80, 0.15 to 0.70, and 0.20 to 0.60. When S2/S3 falls within these ranges, it becomes easier to achieve the effects of ensuring the speed at which the ink is dispensed, as well as of allowing the ink to be used up at the same time.

Further, when Relational Expression (3) is satisfied, it becomes easier to achieve the effect of allowing the ink to be collected into the spout 102, while ensuring a sufficient ink volume. Relational Expression (3) preferably satisfies S1≥D1>S3, more preferably satisfies S1>D1>S3.

Further, when Relational Expression (4) is satisfied, it is possible to achieve the effect of allowing the ink to be collected into the spout 102. D2/S3 preferably includes 0.25 to 0.90, 0.25 to 0.80. S2/D2 preferably includes 0.25 to 0.90, 0.25 to 0.80. Within the above range, it is possible to use up the ink more thoroughly.

Moreover, when the relationship S2>S4 is satisfied, the ink container 100 may have a shoulder-like offset in the profile between the ink container body 101 and the spout 102. Therefore, it is possible to reduce the chances of the ink scattering and contaminating the surroundings, due to sudden discharge of the ink from the outlet 103, as a result of the ink inside the ink container body 101 flowing quickly into the spout 102, while the ink is being refilled. Preferably, S4/S2 is set to 0.20 to 0.99, 0.30 to 0.95, or 0.40 to 0.90, from the viewpoints of suppressing sudden discharge of the ink, as well as of allowing the ink to be used up more smoothly.

The ink contains a coloring material, a solvent, a surfactant, and water, for example. The viscosity and the surface tension of the ink are not limited to particular viscosity and surface tension. Preferably, the viscosity of the ink is 1 to 10 [mPa·s], and more preferably 1 to 5 [mPa·s]. The surface tension of the ink is preferably 20 to 45 [mN/m].

In the present disclosure, even with an ink having certain levels of viscosity and surface tension, it is possible to use up the ink well when Relational Expressions (1) to (4) are satisfied. In particular, when the ink has a viscosity and a surface tension within the ranges described above, and an ink-impermeable material content within the range described above, it tends to be harder to use up the ink. When Relational Expressions (1) to (4) according to the present disclosure are satisfied, even such inks can be used up well.

As to a measurement of the viscosity of an ink, the viscosity at 25° C. was measured using a rotating E-viscometer (trade name “RE80 viscometer”, manufactured by Toki Sangyo Co., Ltd). The viscosity was then measured using a cone rotor at a rotation speed of 50 to 100 rpm.

As to a measurement of the surface tension of the ink, the surface tension at 25° C. was measured using an automatic surface tension meter (trade name “DY-300”, manufactured by Kyowa Interface Science Co., Ltd.) using the Wilhelmy plate method.

In relation to Relational Expressions (1) and (2), FIG. 4 illustrates a side view of an ink container satisfying the relationship 0.25=S3/S1 and 0.04=S2/S3, which are the values at the lower bounds of the respective numerical ranges. This container also satisfies Relational Expressions (3) and (4), so that the ink in the ink container can be used up sufficiently, as described above.

### Second Embodiment

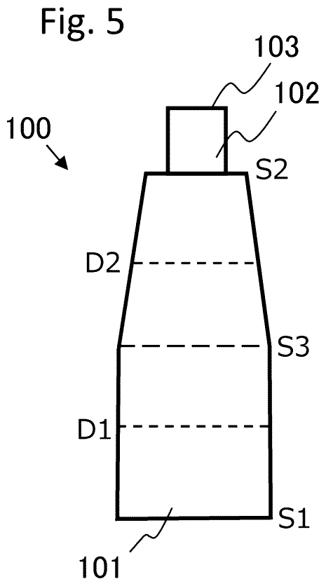

FIG. 5 is a side view of an ink container according to this embodiment of the present disclosure.

In the embodiment illustrated in FIGS. 2, S1, S3, and D1 are in the relationships S3/S1<1 and S1>D1>S3. By contrast, in the embodiment illustrated in FIG. 5, the relationships S3/S1=1 and S1=D1=S3 are satisfied. Accordingly, the side surface from the midpoint S3 to the bottom surface S1 on the lower side of the ink container body 101 of the ink container 100 is perpendicular to the bottom surface.

With such a configuration, when a user holds the ink container 100 by hand, the part forming S1 and S3 has a shape without any angle in directions other than the vertical direction, so that it is easier to hold in a palm. Therefore, the user can supply ink into the inkjet recording apparatus stably. As a result, it is possible to use up the ink more stably, compared with the ink container according to the first embodiment. The other configurations of and effects achieved by this embodiment are the same as those of the first embodiment.

### Third Embodiment

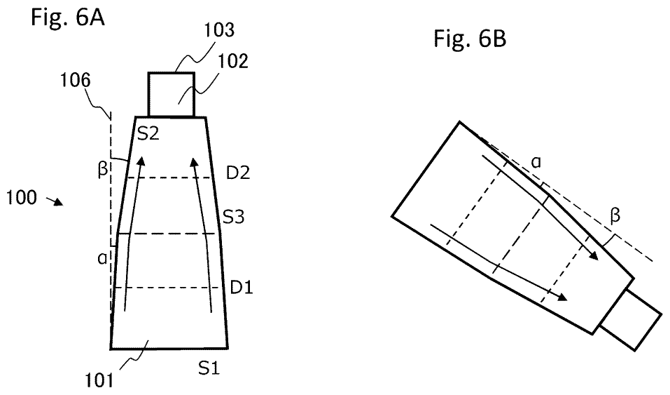

FIG. 6A is a side view of an ink container according to this embodiment of the present disclosure. FIG. 6B is a side view of the ink container at the time of refilling the ink in the third embodiment. The side surface of the ink container body 101 preferably has a position (starting point) at which the angle formed by the side surface with respect to the vertical direction changes.

For example, the angle formed by a line segment connecting the bottom surface and the midpoint along the side surface of the ink container body 101 with respect to the vertical direction is denoted as α, and the angle formed by a line segment connecting the top surface and the midpoint with respect to the vertical direction is denoted as β. Preferably, a relationship α<β is satisfied. β−α is preferably from 1 to 45°, and more preferably, from 3 to 30°.

Specifically, the relationship between the cross-sectional area S1 and the cross-sectional area S3 is S3/S1<1, as illustrated in FIG. 6A, for example. Further, denoting the angle formed by the side surface of the ink container body 101 between the bottom surface and the midpoint with respect to the vertical direction as α, and denoting the angle formed by the side surface between the midpoint and the top surface with respect to the vertical direction as β, a relationship α<β is satisfied. More preferably, the angle formed by the side surface of the ink container body 101 of the ink container 100 with respect to the vertical direction changes, with the midpoint as a start point. In other words, more preferably, the start point is at the midpoint.

With the relationship of α and β described above satisfied, the ink flows through the ink container body 101 at different angles, as illustrated in FIG. 6B, when the ink container 100 is tilted at the time of refilling the ink. Because the flow of the ink changes, the ink can be collected well into the spout 102. As a result, it is possible to use up the ink more thoroughly, compared with in the first embodiment. Furthermore, the ink flowing through the ink container body 101 is allowed to flow more gently from the midpoint toward the top surface, when the ink container 100 is tilted at the time of refilling the ink. Therefore, it is possible to reduce the chances of the ink scattering and contaminating the surroundings due to the ink inside the ink container body 101 flowing quickly into the spout 102 and becoming abruptly discharged from the outlet 103, while the ink is being refilled. The other configurations of and effects achieved by this embodiment are the same as those of the first embodiment.

Although the relationship α<β has been described in this embodiment, it is also possible to change the flow of the ink in the same manner even by using a relationship α>B. With α>B, because the flow of the ink tends to speed up from the midpoint toward the top surface, the ink can be used up more thoroughly.

Further, the position where the angle formed changes may not be a point, or may have a curved shape.

### Fourth Embodiment

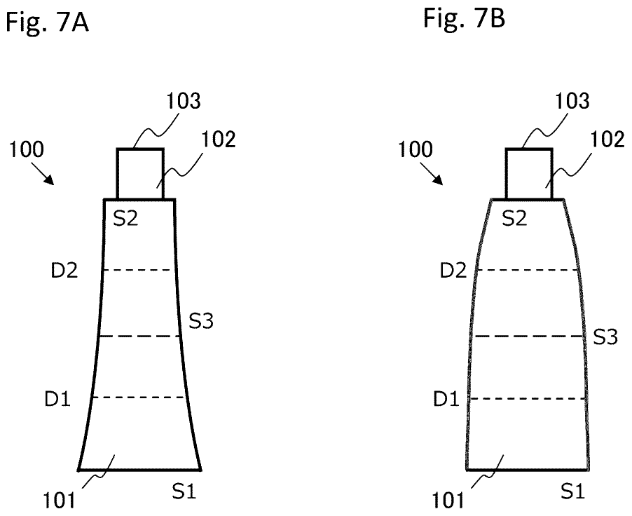

FIGS. 7A and 7B are side views illustrating an ink container according to this embodiment of the present disclosure.

In the first embodiment illustrated in FIGS. 2, S1, S2, and S3 are connected by straight line, from the bottom surface to the top surface. In the embodiment illustrated in FIGS. 7A and 7B, by contrast, the side surface of the ink container body 101 delineates a continuous curve from the bottom surface to the top surface. The curve may be convex with respect to the interior of the container as illustrated in FIG. 7A, or convex with respect to the exterior of the container as illustrated in FIG. 7B.

With a curve that is convex with respect to the interior of the container as illustrated in FIG. 7A, the ink is allowed to flow more smoothly, and to refilled the inkjet recording apparatus. As a result, the ink can be used up more thoroughly, than in the first embodiment.

With a curve that is convex with respect to the exterior of the container as illustrated in FIG. 7B, the ink flows through the ink container body 101 more gently, when the ink container 100 is tilted at the time of refilling the ink. Therefore, it is possible to reduce the chances of the ink scattering and contaminating the surroundings due to the ink inside the ink container body 101 flowing quickly into the spout 102 and becoming abruptly discharged from the outlet 103, while the ink is being refilled. The other configurations of and effects achieved by this embodiment are the same as those of the first embodiment.

### Fifth Embodiment

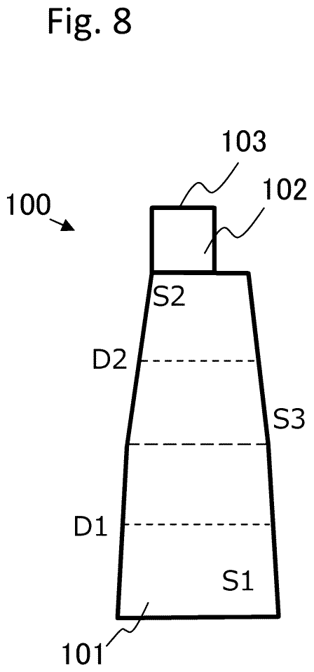

FIG. 8 is a side view of an ink container according to this embodiment of the present disclosure.

In the first embodiment illustrated in FIG. 2, the spout 102 and the outlet 103 of the ink container 100 are provided concentrically with respect to the ink container body 101. However, in this embodiment, the spout 102 and the outlet 103 are positioned offset from the center of the ink container body 101, and the ink container body 101 and the spout 102 are connected linearly without any shoulder-like offset in the profile. In other words, viewing the ink container 100 from the side of the outlet 103 in the vertical direction, the center of the spout 102 is preferably at a position offset from the center of the ink container body 101.

With such a configuration, when the ink container 100 is tilted toward the side on which the spout 102 is offset at the time of refilling the ink, because the ink container body 101 and the spout 102 are connected linearly without any shoulder-like offset in the profile, the ink is allowed to flow more smoothly, and to refill the inkjet recording apparatus. As a result, the ink can be used up more thoroughly than in the first embodiment. The other configurations of and effects achieved by this embodiment are the same as those of the first embodiment.

Ideally, the ink container body 101 and the spout 102 are connected without any offset in profile, as in the left side of the container illustrated in FIG. 8, but the same effects can be achieved even with a shoulder-like offset in profile, as long as the spout 102 and the outlet 103 are provided at a position offset from the center of the ink container body 101.

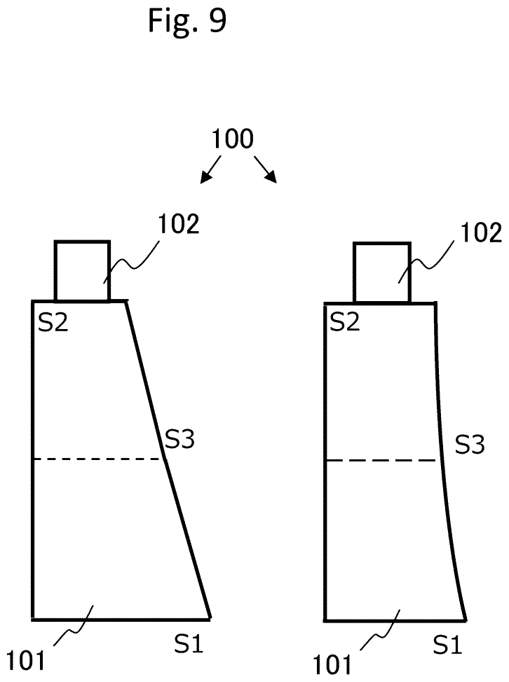

In the embodiments described above, all of the ink container bodies 101 are symmetrical in shape, but the shape does not necessarily need to be symmetrical. The container may be asymmetric, as illustrated in FIG. 9, as long as the relationship of Relational Expressions (1) to (4) above are satisfied, and as long as the left and right side surfaces satisfy any one of the embodiments described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075571, filed May 8, 2024, which is hereby incorporated by reference herein in its entirety.

What is claimed is:

1. An ink container for supplying ink to a receptacle of an ink ejector,
the ink container comprising:
an ink container body configured to hold the ink; and
a spout having an outlet through which the ink held inside the ink container body is dispensed to outside, wherein
the ink container body is formed of a paper material internal of which is covered by a material that is impermeable to ink,
when a horizontal direction is a direction extending along a bottom surface of the ink container body, a vertical direction is a direction perpendicular to the bottom surface; a top surface is a surface on an opposite side of the bottom surface of the ink container body in the vertical direction;
S1 denotes a horizontal cross-sectional area of the bottom surface;
S2 denotes a horizontal cross-sectional area of the top surface;
S3 denotes a horizontal cross-sectional area at a midpoint between the bottom surface and the top surface in the vertical direction;
D1 denotes a horizontal cross-sectional area at a position between the bottom surface and the midpoint in the vertical direction; and
D2 denotes a horizontal cross-sectional area at a position between the midpoint and the top surface in the vertical direction,
the ink container satisfies following Relational Expressions (1) to (4):
$$0.25 \leq S 3 / S 1 \leq 1. ; \qquad ( 1 )$$
$$0.04 \leq S 2 / S 3 < 1. ; \qquad ( 2 )$$
$$S 1 \geq D 1 \geq S 3 ; and \qquad ( 3 )$$
$$S 3 > D 2 > S 2. \qquad ( 4 )$$

2. The ink container according to claim 1, wherein the material impermeable to ink is at least one selected from the group consisting of a plastic film and a coating layer.

3. The ink container according to claim 1, wherein the paper material is mainly a pulp fiber.

4. The ink container according to claim 1, wherein the ink container satisfies a relationship S2>S4 where S4 is a horizontal cross-sectional area of the spout on a side facing the ink container body.

5. The ink container according to claim 1, wherein the ink has a viscosity of 1 to 10 [mPa·s], and
the ink has a surface tension of 20 to 45 [mN/m].

6. The ink container according to claim 1, wherein a side surface of the ink container has a part where an angle formed by the vertical direction and the side surface changes.

7. The ink container according to claim 1, wherein a side surface of the ink container delineates a curved line connecting from the bottom surface to the top surface.

8. The ink container according to claim 1, wherein, in a view of the ink container from a side of the outlet in the vertical direction, the spout has a center at a position offset from a center of the ink container.

9. An ink refill system comprising:
an ink ejector; and
an ink container, wherein
the ink ejector includes:
an ink ejection head;
a receptacle configured to receive an injection of ink from outside; and
an ink tank enabled to supply the ink injected from the receptacle into the ink ejection head, and
the ink container is configured to supply ink into the receptacle, and
the ink container comprising:
an ink container body configured to hold the ink; and
a spout having an outlet through which the ink held inside the ink container body is dispensed to outside, wherein
the ink container body is formed of a paper material internal of which is covered by a material that is impermeable to ink,
when a horizontal direction is a direction extending along a bottom surface of the ink container body, a vertical direction is a direction perpendicular to the bottom surface; a top surface is a surface on an opposite side of the bottom surface of the ink container body in the vertical direction;
S1 denotes a horizontal cross-sectional area of the bottom surface;
S2 denotes a horizontal cross-sectional area of the top surface;
S3 denotes a horizontal cross-sectional area at a midpoint between the bottom surface and the top surface in the vertical direction;
D1 denotes a horizontal cross-sectional area at a position between the bottom surface and the midpoint in the vertical direction; and
D2 denotes a horizontal cross-sectional area at a position between the midpoint and the top surface in the vertical direction,
the ink container satisfies following Relational Expressions (1) to (4):
$$0.25 \leq S 3 / S 1 \leq 1. ; \qquad ( 1 )$$
$$0.04 \leq S 2 / S 3 < 1. ; \qquad ( 2 )$$
$$S 1 \geq D 1 \geq S 3 ; and \qquad ( 3 )$$
$$S 3 > D 2 > S 2. \qquad ( 4 )$$
